(19) United States
(12) Patent Application Publication
(10) Pub. No.: US 2003/0180591 A1
(43) Pub. Date: Sep. 25, 2003

(54) Contact potential difference ionization battery

(76) Inventors: Steven Danyluk, Atlanta, GA (US); Anatoly Zharin, Minsk (BY)

Correspondence Address: FOLEY & LARDNER, 321 NORTH CLARK STREET, SUITE 2800, CHICAGO, IL, 60610-4764, US

(21) Appl. No.: 10/084,535

(22) Filed: Feb. 27, 2002

Related U.S. Application Data
(60) Provisional application No. 60/279,599, filed on Mar. 29, 2001.

(51) Int. Cl. H01M 6/00

(52) U.S. Cl. 429/30

(57) ABSTRACT

A contact potential difference battery and method of application. The battery includes at least two different materials having different Fermi levels and electrically coupled together. A radiation source is disposed near the two materials and an ionizable gas is present therebetween. The radiation emitted by the radiation source ionizes the gas causing the ions to strike the two materials and cause an electric current flow in the circuit. This battery can also be used in groups to multiply current and can also be coupled to a microelectric circuit for providing power needs.

This invention was made in part with U.S. Government support under a grant from the Office of Naval Research Contract No. N000140010374. The U.S. Government has certain rights in this invention.

### FIELD OF THE INVENTION

The present invention is directed generally to an ultra long life battery and more particularly is directed to a contact potential difference ionization battery wherein ionization is provided by a nuclear radiation source.

### BACKGROUND OF THE INVENTION

Numerous battery technologies are well developed and utilized in a variety of consumer and industrial applications, including for example solid state batteries, fuel cells, and conventional liquid based electrolytic systems. These systems, however, all suffer from relatively short terminal life cycles or require recharging at frequent intervals. Further, these systems are often incompatible with delicate electronic systems causing corrosion events and erratic current output to a system.

### SUMMARY OF THE INVENTION

It is therefore an object of the invention to provide an improved battery.

It is another object of the invention to provide an improved ultra long or virtually unlimited life battery.

It is yet another object of the invention to provide an improved contact potential difference battery.

It is an additional object of the invention to provide an improved power source for microelectronic circuits.

It is a further object of the invention to provide an improved ionization source battery.

It is also an object of the invention to provide an improved battery having a highly stable, long life current output.

It is yet an additional object of the invention to provide an improved ionization based battery having no intrinsic corrosive effect on circuit components coupled to the battery.

It also is an additional object of the invention to provide an improved powered electronic circuit having at least one contact potential difference ionization battery integrated therein.

It is yet a further object of the invention to provide an improved battery having a plurality of contact potential difference batteries.

It is also another object of the invention to provide an improved radiation ionization source for activating a contact potential difference battery.

Further advantages and features of the present invention will be apparent from the following description of the drawings, specification and claims which illustrate the preferred embodiments of the invention.

### BRIEF DESCRIPTION OF THE DRAWINGS

FIG. 1 illustrates schematically a contact potential difference battery circuit;

FIG. 2 illustrates schematically an electrical circuit for monitoring the circuit of FIG. 1;

FIG. 3 illustrates schematically the ionization process occurring in the circuit of FIG. 1; and

FIG. 4 illustrates schematically a current multiplier using a plurality of the contact potential difference battery in FIG. 1 and disposed in a microelectric circuit.

### DETAILED DESCRIPTION OF THE PREFERRED EMBODIMENTS

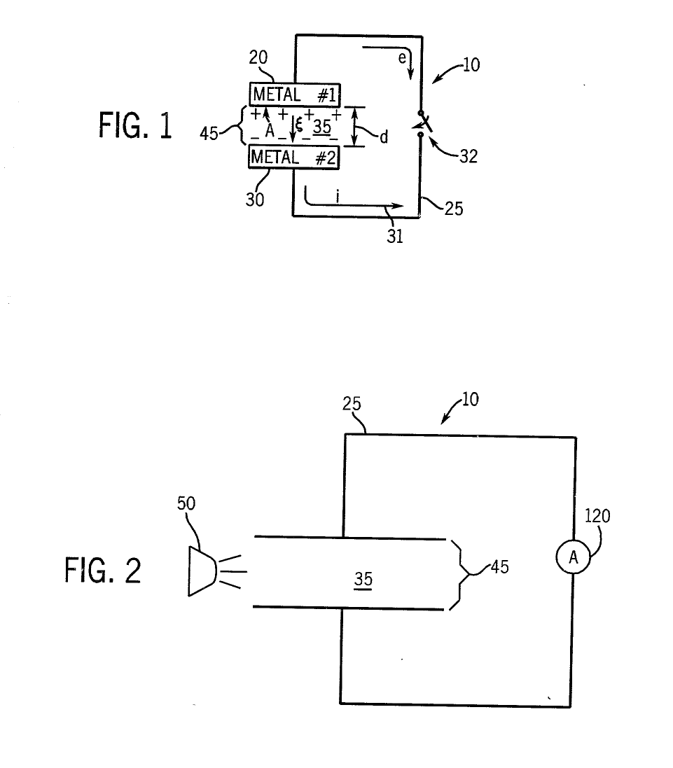

FIG. 1 illustrates a contact potential difference battery 10 constructed in accordance with a preferred form of the invention. The battery 10 includes a first conductive material 20, such as a first metal, is electrically connected to a second conductive material 30, such as a second metal. In particular the battery 10 will contain an electric field, \overline{ε}, which arises between the first conductive material 20 and the second conductive material 30 when the two materials are electrically coupled by connection 25. An ε electric field, \overline{ε}, will form when the Fermi energies of the two materials 20 and 30 are equilibrated, and the field results from the difference of work functions between the first conductive material 20 and the second conductive material 30. The strength of the electric field, \overline{ε}, will depend on the dielectric properties of the medium between materials 20 and 30, ε, of the intergap gas 35 disposed between the two materials 20 and 30, and the permitivity of free space. A contact potential difference voltage will develop between two materials 20 and 30 and the value can be expressed as:

$$V = \frac{1 \; 2}{\vert e \vert} = ϵ d$$

where ω₁ and ω₂ are the work functions of materials 20 and 30, |e| is the magnitude of the electronic charge, and d is the separation of materials 20 and 30.

A transient electrical current i, or 31, will flow when switch 32 is closed and the flow will cease when equilibrium is established. An additional current can be made to flow in the circuit by providing an external source of charge. Referring to FIG. 2, if an ionized gas is present, then the gas molecules will be separated by the contact potential field ε. If a gas is present in the gap 45 between the two materials 30 and 40, then the gas 35 can be ionized by an ionization source, such as a radiation source 50. The gas 30 is preferably N₂ or an inert noble gasbut any non-reactive gas can be used and air can also be used.

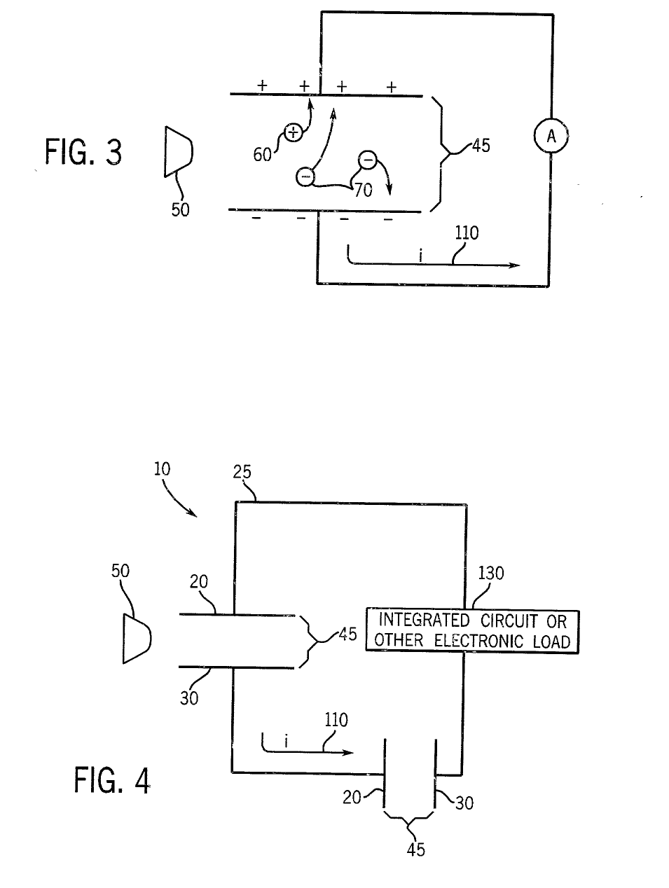

Referring to FIG. 3, the amount of current 110 produced by the ionizing radiation source is given by:

k\dot{η}=ki=CV

where V=ε ε₀ε₁A (where V is proportional to the contact potential difference, and k is a constant of proportionality, \dot{η} is the ionization rate of the gas, proportional to the activity of the radiation producing material, i is the current, C is the capacitance formed by 20 and 30, ε is the field produced by the contact potential difference, ε₀ is the permitivity of free space, ε₁, is the relative dielectric constant and A is the area of the two materials 20 and 30). The ionization rate will depend on the pressure and temperature so these parameters can be adjusted in the operation of the invention.

Referring to FIG. 3 the \overline{ε} field causes positive ions 60 to be accelerated toward the negatively charged one of the two materials 20 and 30, while the negative ions 70 are accelerated to the positively charged one of the two materials 20 and 30. As long as the radiation source 50 is within an effective range, the gas 35 disposed between the two materials 20 and 30 will undergo ionization to activate the battery 10. As the ions 60 and 70 strike the surface of the two materials 20 and 30, an electric current 110 will be produced in the battery 10, and the current 110 can be monitored by an ammeter 120, as shown in FIG. 3. The ionization source, or the radiation source 50, can be any available radiation emitting material, which generates a type of radiation and adequate flux to ionize the gas 35. For example, the radiation source 50 can be a β source like Americium, which is readily available and conventionally used in smoke detectors.

As described hereinbefore, the ionization of the gas 35 is shown in FIG. 3. The resulting level of the current 110 will be proportional to the following non-limiting factors: ionization rate of the gas 35, the strength of the radiation source 50, the efficiency of ionization by the radiation source 50, the area A of the surface of the two materials 20 and 30 facing the gas 35 disposed therebetween, the difference in Fermi levels of the two materials 20 and 30, i.e. the contact potential between the two materials 20 and 30, the pressure of the gas 35, the temperature of the gas 35, the type of constituents of the two materials 20 and 30, the type of gas 35 used and surface condition of the two materials 20 and 30.

Advantageously the ions 60 and 70 do not cause damage or result in corrosion of the two materials 60 and 70, thereby avoiding the need to replace or refurbish the two materials 20 and 30. Consequently, as long as the radiation source 50 is within effective range of the gas 35, the battery 10 will continue to produce the electric current 110. Although the current 110 is quite small from a single one of the ionization battery 10, a plurality of them can be constructed to effectively amplify the current 110 needed for a given functionality (see FIG. 4). This multi component battery 10 can be installed to operate as a continuous power source in a microelectronic circuit 130.

These and other objects, advantages and features of the invention together with the organization and manner of operation thereof will become apparent from the following detailed description when taken into conjunction with the accompanying drawings wherein like elements have like numerals throughout the drawings.

What is claimed is:

1. A contact potential difference battery, comprising:
at least two materials having different work functions and electrically coupled;
a radiation source; and
a gas disposed between the at least two materials, the radiation source emitting a radiation causing ionization of the gas.

2. The contact potential difference battery as defined in claim 1 wherein the radiation source comprises a β emitter.

3. The contact potential difference battery as defined in claim 2 wherein the β emitter comprises Americium.

4. The contact potential difference battery as defined in claim 1 wherein the at least two materials are selected from the group consisting of metals and highly doped semiconductors.

5. The contact potential difference battery as defined in claim 1 wherein the gas is selected from the group consisting of nitrogen and inert noble gases.

6. The contact potential difference battery as defined in claim 1 further including additional ones of the contact potential difference battery coupled in series, thereby multiplying output current.

7. The contact potential difference battery as defined in claim 1 further including a coupled microelectronic circuit.

8. The contact potential difference battery as defined in claim 1 wherein the gas is present at high pressure, thereby providing increased current output.

9. A method of providing continuous, long term current, comprising the steps of:
providing an ionizable gas;
providing at least two electrically coupled separated metals to form a capacitive circuit with the metals having the ionizable gas disposed therebetween;
applying ionizing radiation to form positive and negative ions from the ionizable gas; and
the positive and negative ions each, respectively, striking one of the two different metals to cause a flow of current in the capacitive circuit including the electrically coupled different metals.

10. The method as defined in claim 9 wherein the ionizing radiation is provided from a source disposed adjacent the two different metals within a range effective to cause ionization.

11. A method of providing continuous, long term electrical power to a microelectronic circuit, comprising the steps of:
coupling a contact potential difference battery to a microelectric circuit; and
activating a radiation source to cause current output from the contact potential difference battery to the microelectronic circuit.

12. The method as defined in claim 11 wherein the contact potential difference battery comprises a plurality of individual ones of the contact potential difference battery coupled in series to multiply current output.
